(19) United States
(12) Patent Application Publication
(10) Pub. No.: US 2006/0168391 A1
(43) Pub. Date: Jul. 27, 2006

(54) [FLASH MEMORY STORAGE DEVICE WITH PCI EXPRESS]

(75) Inventors: Wee Kuan Gan, TAIPEI (TW); Jiunn-Yeong Yang, TAIPEI (TW)

Correspondence Address: PHISON ELECTRONICS CORPORATION, 2F-4. NO. 148, SEC. 4, CHUNG HSIAO EAST ROAD, TAIPEI, TW

(73) Assignee: PHISON ELECTRONICS CORP., HSINCHU HSIEN (TW)

(21) Appl. No.: 10/905,901

(22) Filed: Jan. 26, 2005

(51) Int. Cl. G06F 12/00

(52) U.S. Cl. 711/103; 711/115

(57) ABSTRACT

A flash memory storage device with PCI Express includes a microcontroller connected separately to a flash memory and a peripheral component interconnect (PCI) Express connecting interface, and the microcontroller has a flash memory interface and a PCI Express interface, such that when the storage device is coupled to a PCI Express disposed at a host through the PCI Express connecting interface, the host can save data into the storage device and the access rate can meet the standard of the transmission rate of the PCI Express so as to maximize the transmission rate of the storage device.

### BACKGROUND OF THE INVENTION

1. Field of the Invention

The present invention relates to a flash memory with a peripheral component interconnect express (PCI Express), and more particularly to a storage device that uses the PCI Express as a transmission interface.

2. Description of the Related Art

As the science and technology of computers grows in a fast changing manner, a computer tends to be developed with powerful computational functions and a fast speed, and thus the clock of a central processing unit (CPU) is too fast, and the transmission rate of other peripheral equipments cannot catch up with the processing speed of the CPU at all. Even though the CPU continues enhancing its performance, the transmission rate of peripheral equipments cannot be improved much because the overall performance of a computer depends on the whole system. It is necessary to improve the whole computer architecture before the performance of a CPU can be maximized.

However, the data transmission rate depends on the transmission rate of a bus. To enhance the performance of a computer, related manufacturers usually improve the transmission rate of a bus. For example, the transmission rate of an integrated drive electronic (IDE) interface connected to a hard disk drive reaches 160 MG/s; the network line is upgraded from 10 MB/s to 1 GB/s; the transmission rate of the RS-232 is replaced by the 480 MB/s of the universal serial bus (USB), and the present PCI with a transmission rate of 133 MB/s upgrades the transmission rate of its lane to 250 MB/s which is known as a new-generation peripheral component interconnect express (PCI Express). The PCI Express further supports a hot-plug control function. Therefore, the PCI Express is extensively accepted by users.

Further, the flash memory since its announcement gradually replaces the EEPROM or battery power memory in many portable device due to its charming features including low power consumption, non-volatility, shock resistance, and high-capacity storage. With the advanced semiconductor technologies, the storage capacity and transmission rate of a flash memory grow rapidly. The flash memory replaces traditional storage medium such as a hard disk drive in many applications, but most of the present storage devices made of flash memories use the universal serial bus (USB) or integrated drive electronics (IDE) interface as the transmission interface. The transmission rate of the USB and IDE interface are just 480 MB/s and 160 MB/s respectively, and such transmission rate cannot catch up with the accessing speed of the flash memory. Therefore, the applications of a storage device made of this kind of flash memory is restricted by the USB or IDE interface of the host, and its performance cannot be maximized.

Therefore, it is desirable to provide a flash memory storage device that eliminates the aforesaid drawbacks.

### SUMMARY OF THE INVENTION

The present invention has been accomplished under the circumstances in view. Therefore, it is a primary objective of the present invention to use the PCI Express as a transmission interface between a host and a storage device, such that the transmission rate can be maximized when data is accessed in a flash memory of the storage device.

According to the foregoing objective, the storage device includes a microcontroller, and the microcontroller is coupled separately to a flash memory and a PCI Express connecting interface, and the microcontroller has a flash memory interface and a PCI Express interface, such that when the storage device is coupled to a PCI Express disposed at a host through the PCI Express connecting interface, the host saves or reads data in a flash memory of the storage device, and the flash memory interface and PCI Express interface of the microcontroller converts the data into a data format acceptable to the flash memory or the PCI Express, and then sends the converted data to the host or the flash memory so as to meet the standard of the transmission rate of the PCI Express when the host accesses data in the storage device, and maximize the transmission rate of the storage device.

### BRIEF DESCRIPTION OF THE DRAWINGS

FIG. 1 is a block diagram according to a preferred embodiment of the present invention.

FIG. 2 is a schematic diagram of a data transmission according to a preferred embodiment of the present invention.

### DETAILED DESCRIPTION OF THE PREFERRED EMBODIMENT

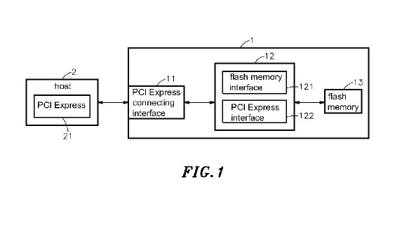

Referring to FIGS. 1, a storage device 1 comprises a peripheral component interconnect express (PCI Express) connecting interface 11, a microcontroller 12 and a flash memory 13.

The PCI Express connecting interface 11 is connected to a PCI Express 21 installed in a host 2.

The microcontroller 12 includes a flash memory interface 121 and a PCI Express interface 122, and the microcontroller 12 is connected to the PCI Express connecting interface 11.

The flash memory 13 is connected to the microcontroller 12.

If the PCI Express connecting interface 11 of the storage device 1 is connected to the PCI Express bus 21, then the microcontroller 12 of the storage device 1 will declare the storage device 1 as an endpoint device to the host 2, and start transmitting data. When the host 2 transmits data to the storage device 1, the data in the host 2 is transmitted to the microcontroller 12 through the PCI Express 21 and the PCI Express connecting interface 11 to the flash memory interface 121 of the microcontroller 12 first and converted into a data format acceptable to the flash memory 13 and then saved into the flash memory 13.

Further, if the host 2 intends to read data in the storage device 1, the flash memory 13 will send the data to the microcontroller 12 first and the PCI Express interface 122 of the microcontroller 12 will convert the data into a data format acceptable to the PCI Express 21 and send the data to the host 2 through the PCI Express connecting interface 11 and the PCI Express 21.

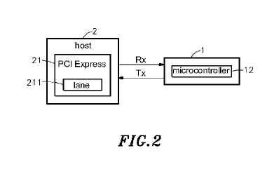

Reference to FIG. 2, the host 2 and the storage device 1 has a lane 211 at a physical layer for transmitting data, and the lane 211 comprises a transmitting end Tx and a receiving end Rx, and the quantity of the lane could be one or more.

Therefore, the key technology for the flash memory storage device with PCI Express in accordance with the present invention to overcome the shortcoming of the prior arts resides on that the invention adopts the PCI Express as the interface between the host and the storage device, so that when the flash memory accesses data, the transmission rate can meet the standard of the PCI Express and thus the transmission rate of the storage device can be maximized.

A prototype of flash memory storage device with PCI Express has been constructed with the features of FIGS. 1˜2. The flash memory storage device with PCI Express functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A flash memory storage device with PCI Express, comprising:
a microcontroller, including a flash memory interface capable of converting a data into a flash memory format and a PCI Express interface capable of converting a data into a PCI Express format;
a flash memory, being coupled to said microcontroller and capable of saving data into or reading data from said flash memory;
a PCI Express connecting interface, being coupled to a PCI Express of a host and coupled to said microcontroller;
thereby if said host saves or read data in said flash memory of said storage device, said flash memory interface and said PCI Express interface of said microcontroller will convert said data into format acceptable to said flash memory or PCI Express and then send said data to said host or said flash memory, such that said host is capable of accessing data in said flash memory through said PCI Express connecting interface.

2. The flash memory storage device as claimed in claim 1, wherein said host and said storage device include a lane disposed at a physical layer for transmitting data, and said lane comprises a transmitting end (Tx) and a receiving end (Rx).

3. The flash memory storage device as claimed in claim 2, wherein said lane has a quantity of one or more.
